(19) United States
(12) Patent Application Publication
(10) Pub. No.: US 2005/0035587 A1
(43) Pub. Date: Feb. 17, 2005

(54) Proposal for portable seat belt

(76) Inventor: Wendell Phillip Sexton, Houston, TX (US)

Correspondence Address: Wendell P. Sexton, 4302 Rosebud Drive, Houston, TX, 77053, US

(21) Appl. No.: 10/639,849

(22) Filed: Aug. 14, 2003

(51) Int. Cl. B60R 22/00

(52) U.S. Cl. 280/801.1

(57) ABSTRACT

My Portable Seat Belt invention is a safety measure that the American D.O.T. is lagging on. The National Highway Traffic Safety Administration feels that The very large buses don't need seat belts because people aren't dying and being injured as on automobiles and airplanes. Heck, I value my life and I don't want to be injured. Every person has a right to feel safe in this world. I don't feel safe riding up and down theses highways without a seat belt. My seat belt is unique because it does not have to be anchored to a vehicle to secure a person to his seat. If a person value his or her life they will buy a seat belt. All of those people on that airplane Aug. 7, 2003 did not get under there seat belt on that plane sure learned a good lesson.

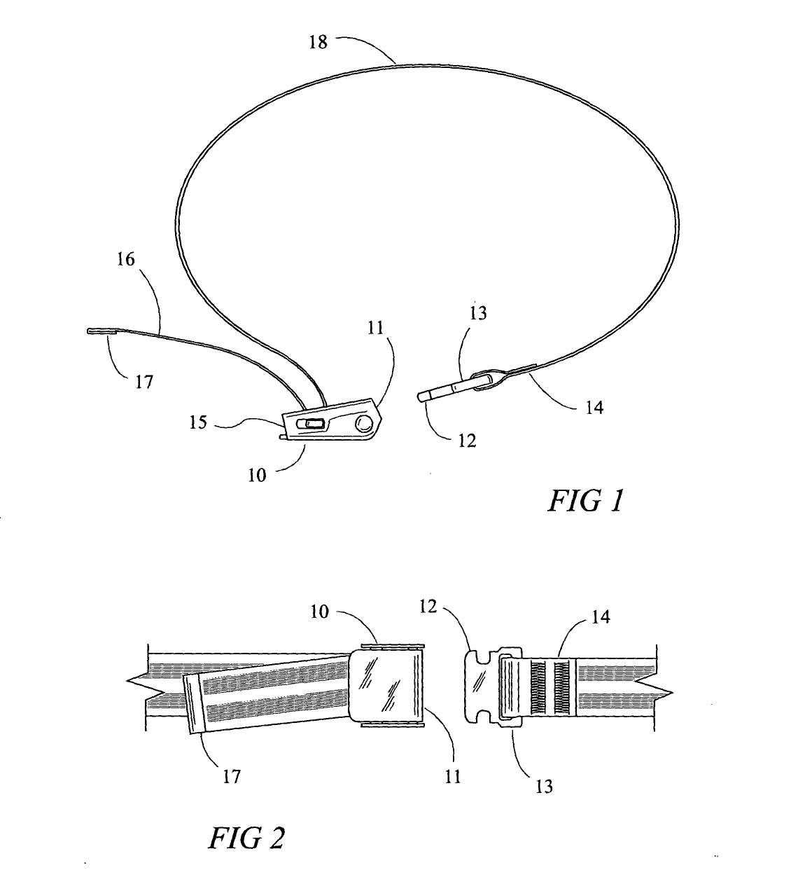

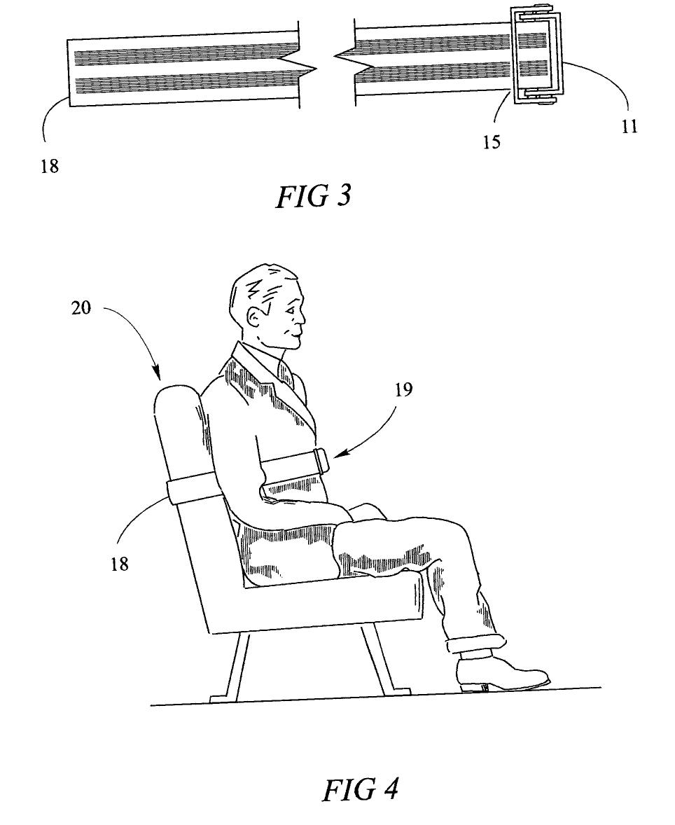

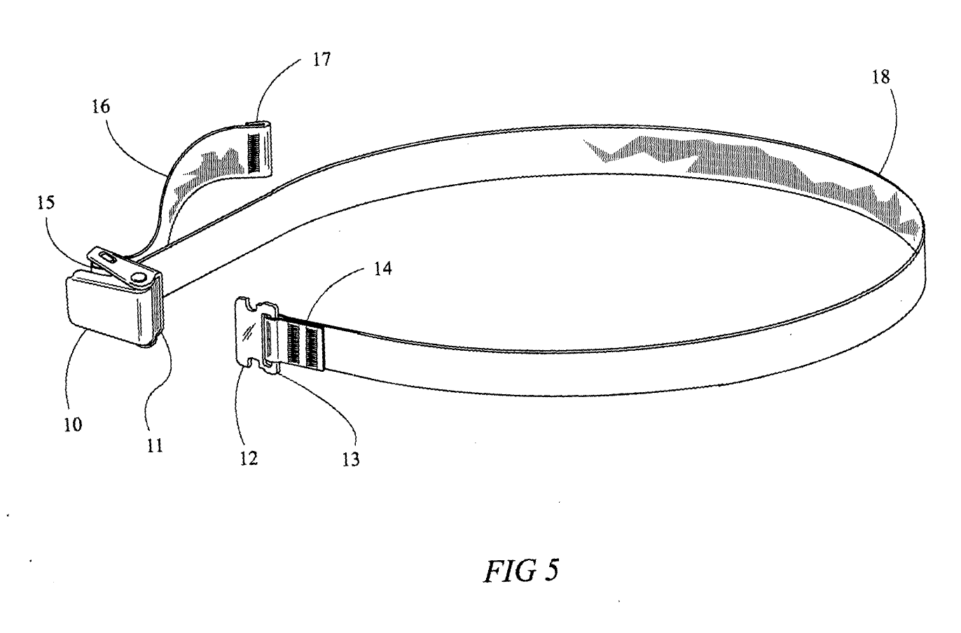

A motorbus in America and around the world is a vehicle designed for long distance transportation of passengers, characterized by integral construction with an elevated passenger deck located over a baggage compartment. It is at least 35 or 40 feet in length and carries more than 30 passenger.

According to the Motorcoach Census 2000 report conducted by the Washington, D.C. research firm R. L. Banks and Associates, Inc. approxi-mately 44,000 commercial motorcoaches are in use for charters, tours, regular route service and special operations in America.

The motorcoach industry is made up of hundreds of private companies, big and small. The United States it is the number one commercial people mover. In 1999 over 774 million passengers in the U.S. traveled by motorcoach to casinos, sightseeing services or popular resort areas, while only 568 by plane and 377 million by Amtrak and commuter rail lines.

Although the bus industry maintains that traveling by motorcoach is very safe, one in ten (10) buses are taken off of the road after failing safety inspections according to the United States Federal Motor Carrier Safety Administration.

The National Safety Council Accident Facts reported that United States interstate motorcoach travel has an average of 4.3 passenger fatalities per year but injuries are crucial.

Here are some bus accidents statistics.
I. Church bus leaving Waco, Tex. hits SUV on Feb. 14, 2003, five (5) on bus killed and dozens of bus riders injured on a rain slick highway.
2. The country of Greece in February or March, 2003 had a bus accident and twenty-one people were killed and 23 persons were injured. The bus was from the Motor Coach Industries, International.
3. In Dallas, Tex., three people were killed on a tour bus and many injured in 2002.
4. Houston, Tex. Metro Bus in June, 2003, over 20 persons injured from a bus accident.
5. There are many more bus accidental injuries.

By inventing this Portable Seat Belt, the rate of fatal accidents and injuries will make a tremendous drop around the world. It can also be used on trains.

This present invention relates to portable seat belts. It encircles the seat around an existing bench seat, such as a school bus, motor or tour buses or train seats. The portable seat belt is one strap with a latchplate on one end and buckle on the other end that fastens in front of the seated person These Portable Seat Belts can be sold, rented to the public or given away as promotional items to faithful casino players.

1. My claim for inventing a Portable Seat Belt is giving a person in America a choice to be or not to be injured or killed. This year alone there have been almost hundreds of people inured and killed on the buses in this world. In Greece there were 21 killed and 23 injured. In Waco, Tex. there were 5 people killed and 29 people were injured. There has been many more people injured on the city buses. I don't understand why seat belts are not put on the Casino and Tour Buses.
These buses are flying up and down highway 10 at 60 and 70 miles an hour waiting for death to consume a lot of people. If there is an accident most of those people are to old to survive a serious accident.
I met a mechanic when I put my truck in the shop. I was telling him about riding a Casino bus from Louisiana about 3 o'clock in the morning. I stated how the driver drove the bus in the center of highway 10 and turned the radio up very loud. He stated how he drove a Tour bus and a tractor trailer for 9 years and that the bus driver was sleepy and was trying to stay awake.
My wife was killed by a sleepy driver 37 years ago.
My invention is giving people a choice of good life or death.
